(19) United States
(12) Patent Application Publication
(10) Pub. No.: US 2011/0106752 A1
(43) Pub. Date: May 5, 2011

(54) System and method of extensible observation for computer network monitoring

(75) Inventor: Andrew Blencowe, Windham, NH (US)

(73) Assignee: ArgSoft Intellectual Property Limited

(21) Appl. No.: 12/149,180

(22) Filed: Apr. 28, 2008

(51) Int. Cl. G06F 17/30

(52) U.S. Cl. 707/602; 707/E17.022

(57) ABSTRACT

Extensible observer system with report management, visual observer, and event management functionality. Uses a component loader for loading new functionality. Leverages data provider, data extractor, and state display components. Includes report manager, report generator, and report propagator. Displays visual observers that include states generated using state display components. Visual observers selectable through hierarchical selector. Manages data-driven events, generating event responses, such as message distribution, based on triggering criteria. Data extractor components used to extract state information. Component generator produces skeleton component code.

### RELATED APPLICATIONS

This application is a utility application claiming priority of U.S. provisional application entitled “SYSTEM AND METHOD FOR MODULARIZED SOFTWARE APPLICATION DEVELOPMENT AND INTEGRATION FOR COMPUTER NETWORK MONITORING” filed Apr. 27, 2007.

### FIELD OF THE INVENTION

The invention relates to extensible observers, tools for monitoring subjects to produce state-driven reports and visuals, wherein run-time loaded components can be incorporated to provide data, parse data, and produce output.

### BACKGROUND OF THE INVENTION

Management of systems is a challenging task in today's technology-driven world. Organizations rely on an increasing number of complex systems to perform everyday tasks. When these systems do not work correctly, organizations suffer. The scope of this task is only increasing as more systems are developed and put into production.

The task of managing systems is made more difficult by the growing sophistication of individual systems. Increased sophistication does more than increase the capabilities of systems; it raises the degree of specialization required by those who manage such systems. This means that reliance on a handful of generalists to provide systems support may not be practicable in many organizations.

Enabling the management of systems is important priority for such organizations. Decision-makers require centralized interfaces to show the health of their system. Indicators of potential problems need to be routed to directly to appropriate experts so that they can prevent or quickly correct problems without delays caused by bureaucratic inefficiencies. The systems for showing the health of various systems can also be diverse and complex. Aggregating and enabling quick action in response to the systems for showing the health of various systems is itself a challenging task.

Observers help in the management of systems by collecting data and reporting on the health of systems. It is not uncommon for organizations to employ a multitude of observers to help in managing their systems. Unfortunately, the plethora of observers can quickly create their own systems management problems. For example, each observer may require maintenance work as systems change. When expertise on maintaining individual observers is lost, some observers can become obsolete, impairing organizations that still rely on the observed systems.

Unfortunately, no single monolithic observer can handle all of the tasks required for effective management of systems. Discrete systems have their own interfaces and quirks that require some customization of observer functionality.

Thus, there exists a need for an extensible observer that can help in the management of systems, but that enables tailoring of its functionality for each system.

### SUMMARY OF THE INVENTION

An extensible observer system includes a component loader that enables new functionality to be loaded into the observer at run-time. It can include report management functionality, visual observer functionality, or event management functionality.

An extensible observer system with report management functionality uses a report manager that uses a component loader to feed data acquired from a data provider component into a report generator to produce reports. Such reports may be displayed using a generated reports interface.

Report management functionality may also include the propagation of reports to at least one destination based on a report propagation trigger rule, which can be as simple as a scheduled for propagating reports. Propagation of the location of a generated report is an alternative to propagation of the report itself.

An extensible observer with visual observer functionality displays states using state display components that are referenced by a selected visual observer interface. The selected visual observer may be selected from a plurality of visual observers using a visual observer selector, which may be implemented as a hierarchical selector in which visual observer interface choices are represented as leaf nodes grouped under branches.

An extensible observer with event management functionality uses a data manager to extract state information available at a data source location using a data extractor component. This data extractor component may be fed data in chunks of end-of-record delimited data. The data manager generates response events if the extracted state information meets criteria defined by a trigger event rule.

An extensible observer may also provide component generator interfaces to help in generating components for extending management functionality, visual observer functionality, or event management functionality.

### BRIEF DESCRIPTION OF THE DRAWINGS

FIG. 1 shows the report definition interface of the report manager with a report definition selector interface.

FIG. 2 shows a generated report being displayed by the generated report interface of the report manager.

FIG. 3 shows the report propagation interface being used to create a report propagation definition that will cause reports to be delivered by email.

FIG. 4 shows the components generator.

FIG. 5 shows a visual observer interface displaying several state displays.

FIG. 6 shows a visual observer selector along with a selected visual observer interface.

FIG. 7 shows a data parsing interface.

FIG. 8 shows a response event interface that defines an email response event.

FIG. 9 shows a Unified Modeling Language use case diagram of the extensible observer.

### DETAILED DESCRIPTION

The following are definitions of some of the terms used in the detailed description:

COMPONENT GENERATOR: A tool that generates a skeleton component. A component generator can simply produce a skeleton component upon invocation. A component generator can also elicit information about the new component, through tools such as wizards or dialog boxes, to tailor the skeleton component for a particular task. Further steps may be needed to make a skeleton component useable.

COMPONENT LOADER: A mechanism that adds functionality to a system at run-time by incorporating an external component. Component loaders can access functionality embedded in variety of external component sources such as dynamically-linked libraries, ActiveX® controls, JavaBeans®, shared libraries, remote libraries, external programs or scripts, remote services, or templates. Component loaders do not necessarily have to load a component directly given a reference to the component. In many instances, a component loader may use an intermediate component broker that either provides the component loader with the details needed to load the component or that itself loads the component.

DESTINATION: An identifier for where to send data. Common destination's include email addresses, cell phone numbers for short message services, pager numbers, network message identifiers, external programs or scripts, and data storage locations.

END-OF-RECORD (EOR): A record terminator that can be used to delimitate records. These terminators are commonly new line and/or carriage return characters at the end of a line of data in human-readable files. In binary files or data streams, the end-of-record may be indicated in a number of ways, including the null character, the ASCII record separator character, a sequence of value's used to delimitate discrete records, or the end of the file or stream.

EXTRACTOR: A tool for extracting data from a data source, often through processes such as parsing data in a log, reading data stored in a binary format, or selecting data through an external tool such as a database system. The data source can contain binary data or human-readable data.

FEED: Transferring data to a component in support of a task can be done in a number of ways. For example, data may be fed through invocation of function calls, where the data is passed as parameters to the functions. Data may be stored at a common location where the component can then retrieve the data. A shared memory location can be used to feed data or a data stream, such as a network connection or pipe, can be used to feed data. Data feeding to a target component does not have to be direct. Data can be fed to components, modules, or tools that subsequently feed the data to the target component.

HIERARCHICAL SELECTOR: An interface that allows for navigation of a hierarchy of options. Trees, where branches can be hidden and expanded, are common hierarchical selectors, but equivalents that are well known in the art, such as hyperbolic trees, tabbed interfaces, or nested menus, are also hierarchical selectors.

INTERFACE: A tool for interacting with the user. This can include many tools or user interaction, such as windows, dialog boxes, wizards, web pages, forms, and text and graphic displays. Interfaces may themselves contain interfaces. An interface can be formed by multiple discrete interfaces.

INVOKE: A user step taken to trigger an action. This may be any number of steps, such as a mouse click or double-click, a right mouse-click, hovering the mouse pointer in an area, using the keyboard, speaking into a microphone, or touching a touch-screen interface.

LOCATION: A set of criteria establishing where data can be stored or found. Common locations include file paths, directory paths, shared network paths (e.g., using the Universal Naming Convention or UNC), uniform resource locators (URLs), and database and database entry identifiers. The criteria set for a location may include details such as authentication information. The criteria for storing information may differ from the criteria for retrieving information. For example, data might be stored using an authenticated file transfer protocol (FTP) and then retrieved through an unauthenticated hypertext transfer protocol session (HTTP).

REPORT: A summary of data, often in the form of a set of human-readable graphs, tables, and diagrams. A report may be in a format designed for consumption by another system.

RESPONSE EVENT: Response events can include, but are not limited to, actions such as notification or an automated corrective action via pager, e-mail, short message service (SMS); network messages, Windows® Command Line scripts and batch files, or Unix® shell scripts.

SELECTOR: A broad term used to include a number of interfaces such as an icon, a radio button, a checkbox, a text field, a drop-down list, a multi-list, a pop-up dialog box, a push button, or any number of equivalent interfaces for acquiring data.

STATE DISPLAY: An interface to show information about a subject system. This information may be current or it may be past information. The information may even be projected future information. A state display is typically a graphical indicator of some aspect of health of a system, but it can be a table, number, or even just a flag.

SUBJECT SYSTEM: A system that is being observed. Subject systems can be any number of things that can be observed. A computer can be a subject system, but so can the software running on the computer, the physical components of the computer, or external devices connected to computer. Network behavior can be observed, thus a network can be a subject system.

TRIGGER EVENT RULE: Criteria for taking some action. There are many potential sources of trigger event rules. Common ones include the system clock reaching a set time for a scheduled event, a metric—such as system memory usage—passing a threshold value, a system being unresponsive, or a particular string appearing in a log entry.

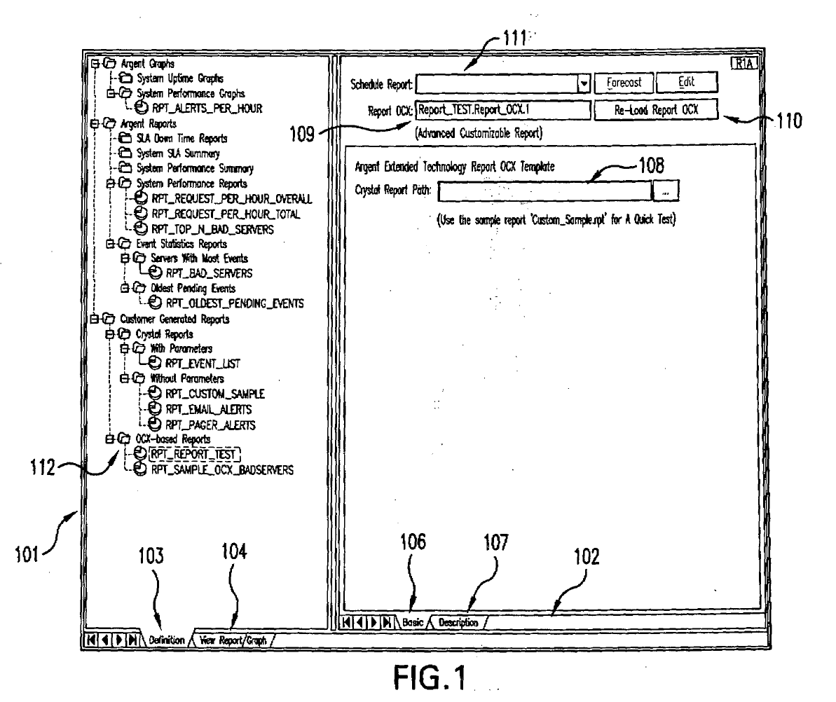

FIG. 1 shows an interface containing a report definition selector interface 101 in which a report definition has been selected 112 and is show juxtaposed with a report definition interface 102. From this interface, the user can view the selected report through the generated report interface 203 by invoking the view report selector 104, at which point the report definition selector interface 101 and report definition interface 102 can be brought back by invoking the report definition interface selector 103. The user can also bring up documentation for a report definition by invoking the report definition documentation selector 107, at which point the user can return to the report definition using the report definition interface selector 106.

In the report definition interface 102, the user can select a data provider component through the data provider component select 109, thus creating a reference to the data provider component. The user can also select a report generator component using the report generator component selector 108, thus creating a reference to a report generator component. The report definition interface shown enables the user to reload a data provider component by invoking the data provider component reloader selector 110. This can be useful in situations where the user is actively developing and testing a new data provider component. The report definition interface also enables the user to select a report propagation definition through the report propagation definition selector 111, thus creating a reference to the report propagation definition.

In the preferred embodiment, the user uses the report generator component selector 108 to select a Crystal Reports® report template. The report generator can then feed data acquired from the data provider component into Crystal Reports®, which can then use the report template to generate a report.

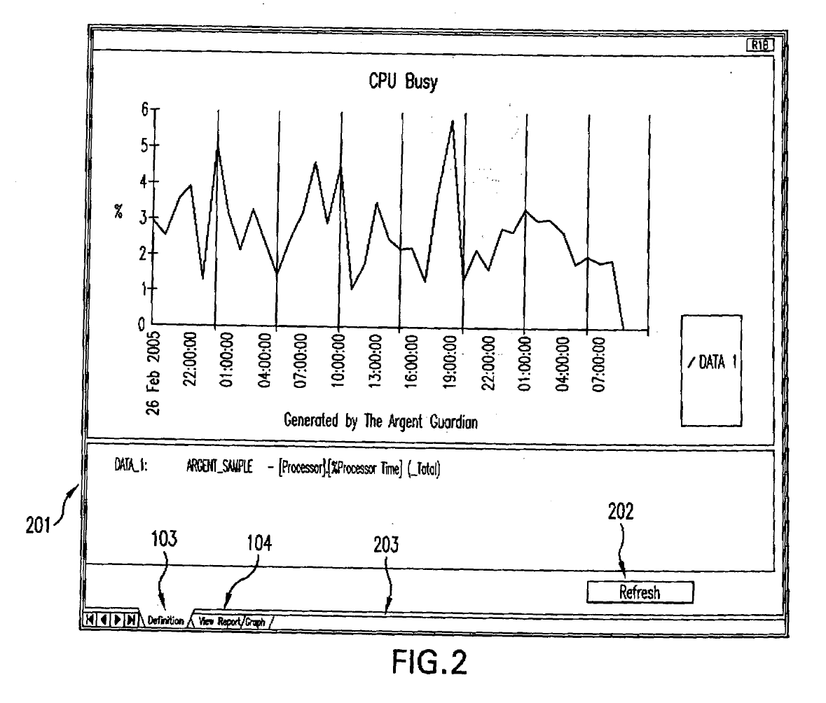

FIG. 2 shows a generated report 201 being displayed through the generated report interface 203. From this interface, the user can switch to the report definition selector interface 101 and report definition interface 102 by invoking the report definition interface selector 103, at which point the user can switch back to the generated report interface by invoking the view report selector 104. In this interface, the user can force the generated report interface to re-generated the report by invoking the refresh report selector 202.

The generated report 201 shown comprises a report title 205, data source description 211, graph 204, and legend 206. The graph 204 comprises at least one axis label 207, a plurality of axis values 208 and 209, and data points 212.

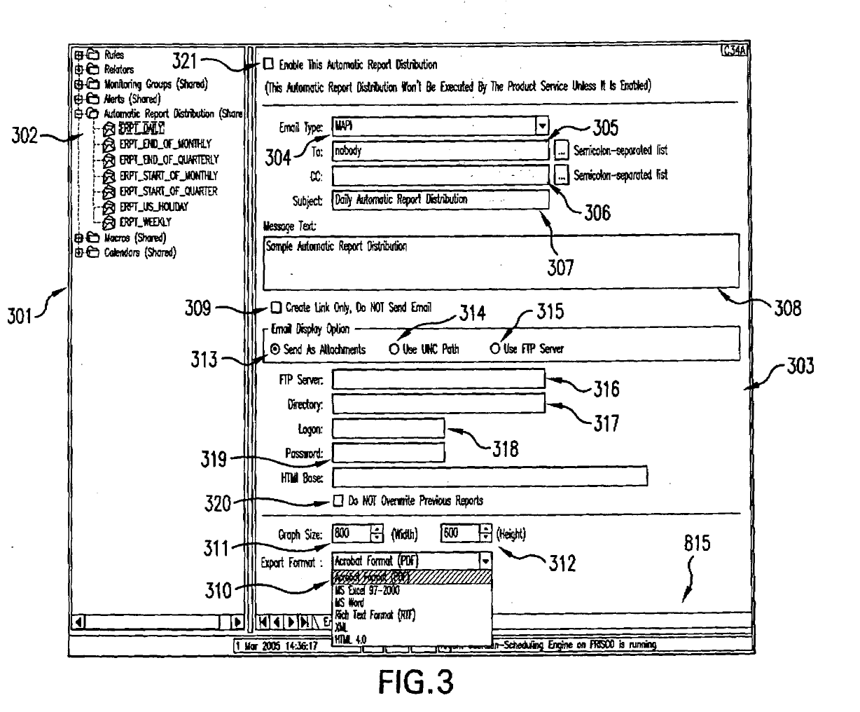

FIG. 3 shows a report propagation definition selector 301 with a selected report propagation definition 302 shown on a juxtaposed report propagation interface 303. The report propagation definition interface 303 in the preferred embodiment includes a message type selector 304, a destination selector 305, and a plurality of one or more message selectors, including a subject line selector 307 and a message text selector 308. The preferred embodiment also has a courtesy copy destination selector 306.

The report propagation definition interface 303 provides access to options that affect the generated reports, including a plurality of report dimension selectors 311 and 312, and a report format selector 310. In the preferred embodiment, the report dimension selector 311 allows specification of a report width in pixel units, the report dimension selector 312 allows specification of a report height in pixel units, and formats available through the report format selector 310 include the Adobe® Portable Document Format (PDF), Microsoft® Excel®, Microsoft® Word®, Rich Text Format, extensible markup language (XML), and hypertext markup language (HTML). Those of ordinary skill in the art could enable the use of other units of dimension, such as inches or centimeters, or other report formats, such as plain text.

The preferred embodiment of the report propagator can propagate email messages. In the preferred embodiment, the method of propagating the report by email can be varied. For example, a report can be propagated to destination email addresses by directly attaching it. This is the method used if the send as attachment selector 313 is selected. Another propagation option that may be useful when recipients have access to a shared file location is the method of storing the report in a file repository such as a file directory and sending the path to the report to recipients. This propagation method can be chosen using the file path selector 314. Still another propagation option is to provide access to the report file by propagate a Uniform Resource Locator (URL) that provides access to the report. In the preferred embodiment, this method can be selected through the remote server selector 315.

If a remote server selector 315 is selected, then remote server destination selectors 316, 317, 318, and 319 are enabled so that destination information can be provided to enable the report propagator can store generated reports. In the preferred embodiment, the remote server is a File Transfer Protocol (FTP) server and the remote server destination selectors include an FTP server name selector 316, an FTP destination directory selector 317, an FTP username 318, and an FTP password 319. One of ordinary skill in the art would know how to substitute different types of equivalent remote server types for report storage and how to choose appropriate remote server access selectors for other types of equivalent remote server types.

The report propagator interface may provide an old report protector selector 320 that, if selected, will prevent the report propagator from overwriting old reports. An equivalent to this selector would be an overwrite selector that enables the report propagator to overwrite old reports.

The report propagator interface also provides a message suppression selector 309, that if selected, will prevent the report propagator from sending the propagation messages when a report is generated. The report will still be available, but users will have to pull it from the destination repository and will not receive notice that it has been generated. This can be useful in collecting metrics on a frequent basis without overwhelming personnel with notices when immediate notice is not necessary. An equivalent to the message suppression selector 309 would be a message enabler selector that enables the report propagator to send out report propagation messages.

The report propagator interface may also provide a report propagation enabler selector 321 that must be selected for the report propagator to propagate reports. An equivalent to this selector would be a report propagation disabler selector that suppresses the report propagation.

Report propagation trigger event rules must be defined to trigger report propagation. In the preferred embodiment, report propagation trigger event rules are defined through at least one report propagation trigger event rule interface tailored to the type of events supported. For example, a calendar may be used to schedule report propagation for set dates. Thus, the current date could be the source of a report propagation trigger event.

In the preferred embodiment, report propagation trigger event rules include report propagation frequency. In the preferred embodiment, possible report propagation frequencies include the following: daily, end of monthly, end of quarterly, start of monthly, start of quarter, U.S. holidays, and weekly.

When a report propagation trigger rule's criteria are met, all enabled report generation definitions that refer to the triggering report propagation rule will be triggered, producing reports that will then be propagated in accordance with their respective report propagation definitions.

The report propagation interface can be enhanced with features from the message template interface, such as integration of macros and variables and support for test message generation.

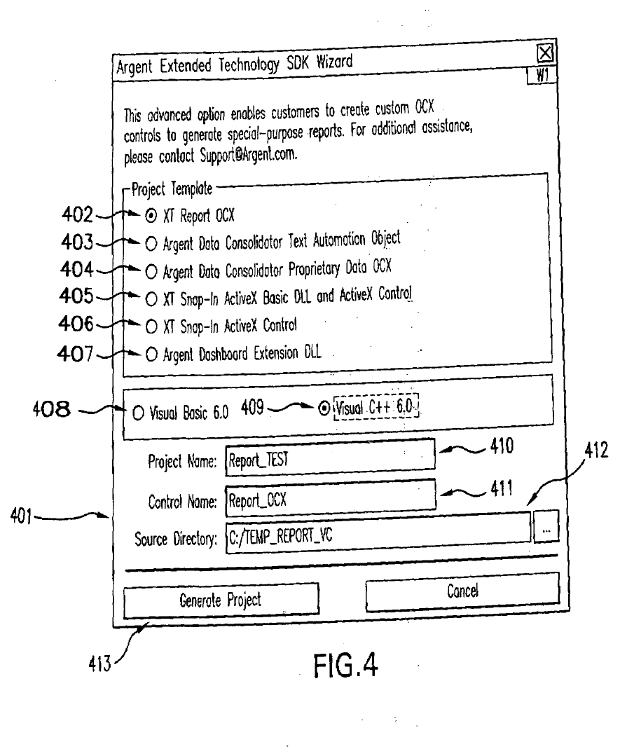

FIG. 4 shows the components generator 401. This tool can be invoked to generated skeleton code for many of the components used by the extensible observer. To create skeleton code for a component, first the user selects one of the component type selectors 402-407, then the user selects the type of skeleton code to produce, using one of the code type selectors 408 or 409, then the user enters a project name into the project name selector 410, a control name in the control name selector 411, and a director for the project in the project directory selector 412, before invoking the generate skeleton component selector 413. In the preferred embodiment, the component type selectors include a data provider selector 402, a end-of-record delimited data extractor component selector 403, a black-box data extractor component selector 404, a state display component package and state display component selector 405, a state display component selector 406 for adding a new state display component into a state display package, and a visual observer component selector 407. In the preferred embodiment, the code type selectors include a Visual Basic selector 408 and a Visual C++ selector 409. In the preferred embodiment, upon generating a component, the components generator will open the generated code for the user and display instructions for incorporating the component into the extensible observer.

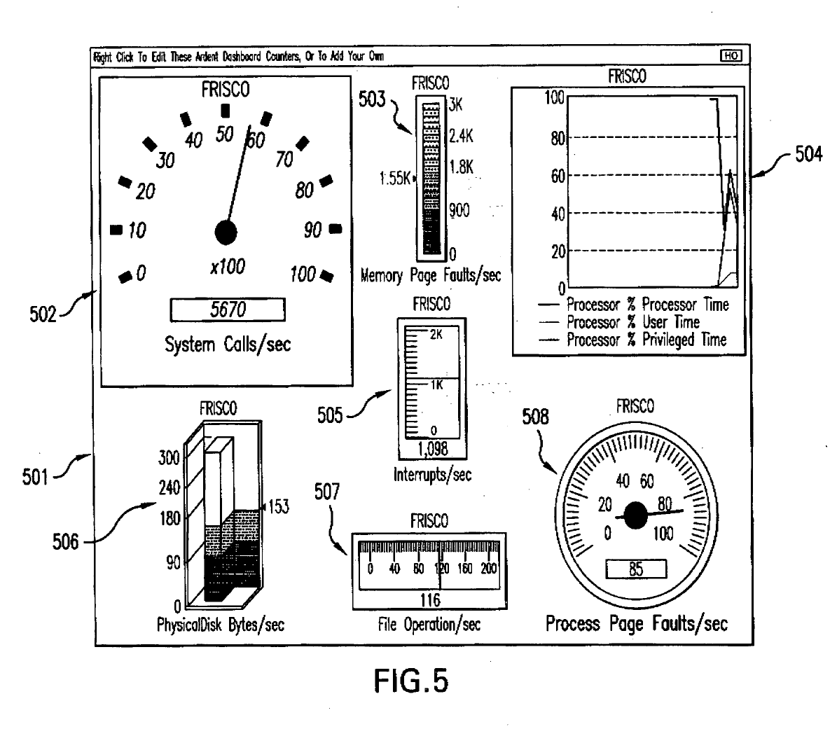

FIG. 5 shows a visual observer interface 501 displaying several state displays 502-508. State displays are useful alternatives to reports for monitoring the state of a subject system. Visual observer interfaces consolidate multiple state displays into a single interface, enabling rapid assessment of a subject systems health.

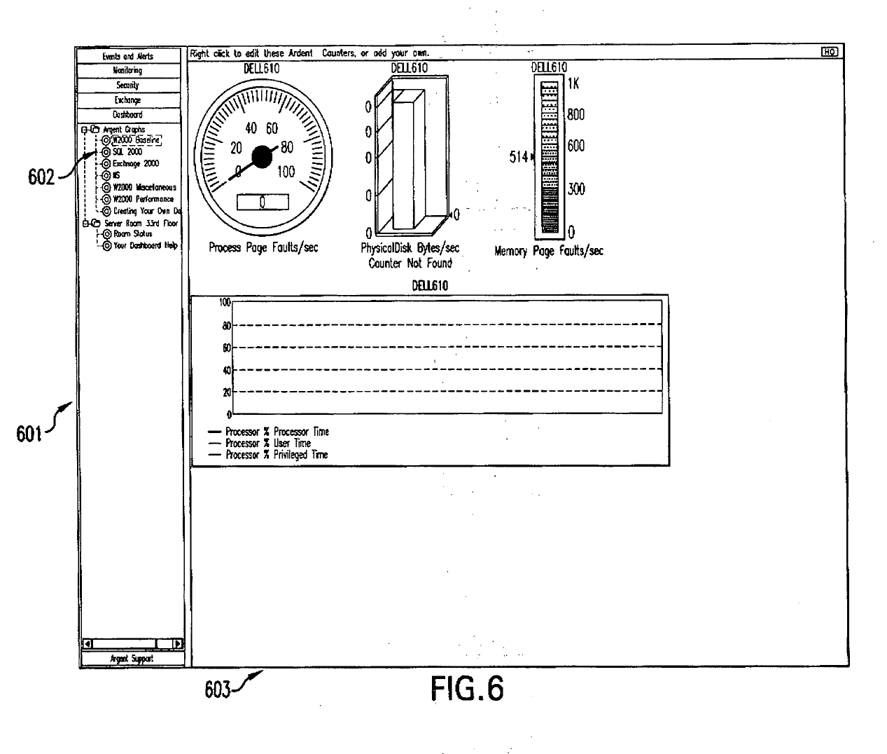

FIG. 6 shows a visual observer selector 601 with a visual observer interface selector 602 selected and the corresponding visual observer interface 603 displayed. The visual observer selector 601 shown is a hierarchical selector, with visual observer interface choices shown as leaf nodes grouped under branch nodes. Non-hierarchical selectors, such as straight lists or a set of icons, would also be effective. Using a hierarchical selector for the visual observer interface 601 has the advantage of enabling centralized management of a large number of systems from the extensible observer. With non-hierarchical selectors, the hassle of trying to navigate through a cluttered set of selectors can impose a serious burden on the user and reduce the effectiveness of the system in helping to quickly assess the health of subject systems.

It is often not enough to monitor the health of system or to review reports. Sometimes events occur that require immediate attention. In some cases the attention required can be automated. In other cases, human intervention may be required. To facilitate this need, the preferred embodiment of the extensible observer includes an event manager.

In the preferred embodiment of the invention, the event manager includes a set of user-defined trigger event rules, which can be defined through trigger event rule interfaces that are defined based on the type of trigger event rules supported. When the state of a subject system is one that falls within a trigger event rule, then the event manager will generate the related response events tied to the trigger event rule.

One source of subject system state that can be used by trigger event rules is data available at defined location. In the preferred embodiment of the invention, a data extractor component can be identified for extracting state information from the data at the defined location.

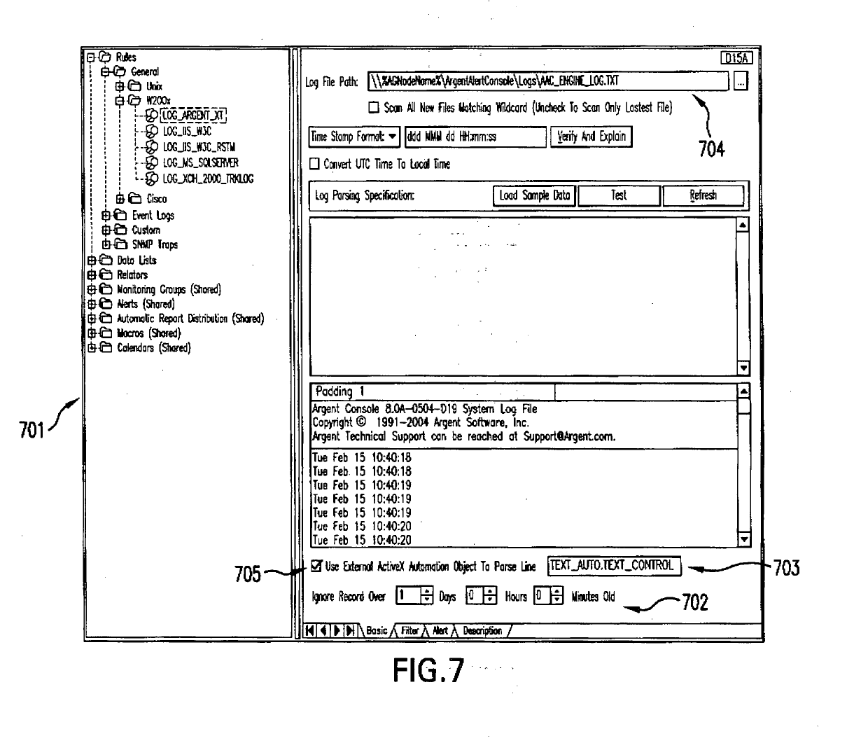

FIG. 7 shows a rules selector interface 701 juxtaposed with a data parsing interface 702. The data parsing interface 702 includes a data source location selector 704. The use external data extractor component selector 705 has been selected and a data extractor component has been selected in the data extractor component selector 703, thus creating a reference to the data extractor component.

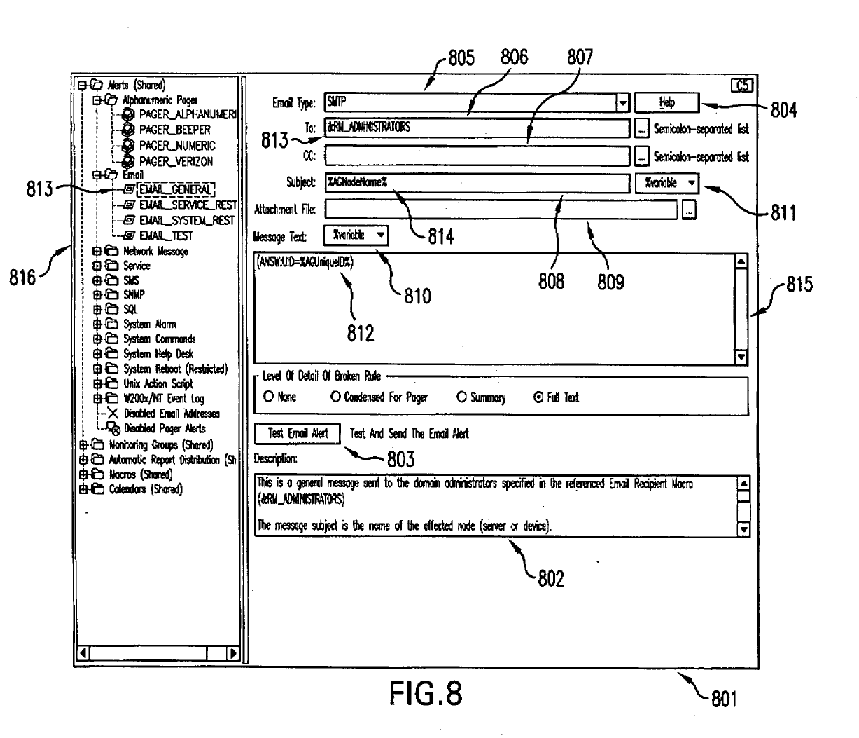

FIG. 8 shows a response event selector 816 with a selected response event 813 show in the response event interface 801. The response event in this figure defines an email response event. This response event interface 801 includes a message type selector 805, a plurality of destination selectors, a “To” destination selector 806 and a “CC” destination selector 807, and a plurality of content selectors: a subject line selector 814, a file attachment selector 809, and a message content selector 815. It also includes a description entered through a response event description selector 802.

The plurality of destination selectors 806 and 807 and the plurality of content selectors 814, 809, and 815, can be marked with macros, indicators to the event manager to perform additional steps to acquire values for these selectors when generating a response event. In the preferred embodiment macros are identified as text preceded by an ampersand (“&”) as shown in 813.

The plurality of content selectors 814, 809, and 815 also allow variables to be used. The variables are identified as text surrounded by percent signs (“%”) as shown in 812. The message template interface 801 in the preferred embodiment includes a plurality of variable selectors 811 and 810 that, when invoked, provide quick access to available parameters. The value of the variables are used in place of the variable placeholders during the generation of a response event.

In the preferred embodiment, the user can test out a response event definition by invoking the test response event selector 803.

The preferred embodiment of the invention includes multiple response event methods, including: pager, e-mail, short message service (SMS), network message, execution of a Windows® Command Line script or batch file, and execution of a Unix® shell script. One of ordinary skill in the art would be able to create the equivalent event response interfaces for these types of messages and their equivalents.

When generating a response event, the event manager must use the response event definition to control the behavior of the response event. For example, an email response event would require producing an email with the defined content and emailing it to the destinations selected.

FIG. 9 shows a Unified Modeling Language use case diagram of the extensible observer 901. The user 902 can interact with the extensible observer 901 in several ways, including defining a report 906, view a report 907, create a report propagation definition 922, view subject system states 912, define a trigger event rule 915, define a response event 916, or generate a component 918. Viewing a report 907 generates a report 910 by acquiring data 911 from a data provider component 903. When the extensible observer 901 propagates a report 908, it also generates a report 910. When the user 902 views subject system states 912, the extensible observer 901 uses one or more state display components 905. The extensible observer 901 responds to events 917 by extracting data 913 using a data extractor component 904. The data extraction 913 can be broken into end-of-record delimited chunks 914. The user 902 has several choices when generating a component 918, including generating a data provider component 919, generating a state display component 920, or generating a data extractor component 921.

While various embodiments of the present invention have been described above, it should be understood that they have been presented by way of example, and not limitation. It will be apparent to persons skilled in the relevant art(s) that various changes in form and detail can be made therein without departing from the spirit and scope of embodiments of the present invention. Thus, embodiments of the present invention should not be limited by any of the above-described exemplary embodiments, but should be defined only in accordance with the following claims and their equivalents.

In addition, it should be understood that the figures in the attachments, which highlight the structure, methodology, functionality and advantages of embodiments of the present invention, are presented for example purposes only. Embodiments of the present invention are sufficiently flexible and configurable, such that it may be implemented in ways other than that shown in the accompanying figures.

1. An extensible observer system comprising:
a component loader,
a report definition interface that is used to create a report definition having a reference to a data provider component,
a report generator, and
a report manager, wherein the report manager uses the component loader to feed data acquired from the data provider component to the report generator to produce a report.

2. The system of claim 1 further comprising a generated report interface to display the report.

3. The system of claim 1 wherein the component loader uses a component broker to load the data provider component.

4. The system of claim 1 wherein the report generator uses at least one external report generator component.

5. The system of claim 1:
wherein the system further comprises a report propagation interface that is used to create a report propagation definition having a destination and a report propagation trigger event rule,
wherein the report definition further comprises a reference to the report propagation definition, and
wherein the report manager generates the report when the report propagation trigger event rule criteria is met.

6. The system of claim 5 wherein the report manager also distributes the report to the destination.

7. A computer-usable medium having computer-readable program code implementing the system of claim 6.

8. The system of claim 5:
wherein the report has a report location and
wherein the report manager distributes the report location to the destination.

9. The system of claim 1 further comprising a data provider component generator.

10. An extensible observer system comprising:
a component loader,
a plurality of visual observer interfaces, each having a source data provider and a plurality of references to state display components, and
a selected visual observer interface, wherein the selected visual observer interface uses the component loader to display a plurality of states using state displays generated by feeding data from the source data provider into the state display components.

11. The system of claim 10 wherein the extensible observer system further comprises a visual observer selector that enables the selection of the selected visual observer interface from the plurality of visual observer interfaces.

12. The system of claim 11 wherein the visual observer selector is a hierarchical selector, wherein choices defined by the plurality of visual observer interfaces are shown as leaf nodes grouped under branch nodes.

13. A computer-usable medium having computer-readable program code implementing the system of claim 12.

14. The system of claim 13 further comprising a state display component generator.

15. An extensible observer system comprising:
a component loader,
a data manager having a data source location and a reference to a data extractor component, wherein the data manager uses the component loader to extract state information by feeding data available at the data source location into the data extractor component.

16. The system of claim 15 wherein the process of feeding the data available at the data source location into the data extractor component is performed separately for chunks of data delimited by end-of-record terminators.

17. The system of claim 15 further comprising a data extractor component generator.

18. The system of claim 15 further comprising:
a trigger event rule interface used to define a trigger event rule,
a response event interface used to define a response event definition, and
an event manager, wherein the event manage generates a response event using the response event definition when the extracted state information meets criteria defined by the trigger event rule associated with the response event.

19. A computer-usable medium having computer-readable program code implementing the system of claim 18.
